(19) United States
(12) Patent Application Publication
(10) Pub. No.: US 2025/0083386 A1
(43) Pub. Date: Mar. 13, 2025

(54) APPARATUS AND METHOD FOR CHANGING LASER SPOT SIZE IN AN ADDITIVE MANUFACTURING MACHINE

(71) Applicant: Electroimpact, Inc., Mukilteo, WA (US)

(72) Inventors: Ryan BISCHOFF, Shoreline, WA (US); Benjamin Lee LARKIN, Kirkland, WA (US)

(21) Appl. No.: 18/828,479

(22) Filed: Sep. 9, 2024

Related U.S. Application Data
(60) Provisional application No. 63/581,618, filed on Sep. 8, 2023.

(51) Int. Cl. B29C 64/268; B23K 26/03; B29C 64/30; B29C 64/379; B33Y 10/00; B33Y 30/00

(52) U.S. Cl. CPC B29C 64/268; B23K 26/032; B29C 64/30; B29C 64/379; B33Y 10/00; B33Y 30/00

(57) ABSTRACT

A laser focusing telescope includes one or more lenses arranged to focus a laser beam to a size corresponding with a selected tow width. An additive manufacturing machine selects an appropriate laser focusing telescope from a plurality of laser focusing telescopes each having an arrangement of one or more lenses that corresponds to a respective different tow width.

This application claims benefit of priority to U.S. Provisional Patent Application No. 63/581,618 filed Sep. 8, 2023, the contents of which are incorporated herein by reference thereto.

### BACKGROUND

Additive Manufacturing Machines (AMMs) add layers of fiber material, known as tow, to a workpiece, often in narrow strips. Some AMMs include an articulable robotic arm having an end effector that feeds the tow from a reel and presses the tow against the workpiece. Conventionally, the tow is heated as it is pressed to a substrate on a workpiece, activating adhesive elements of the tow for fixing the tow to the substrate. As the tow is applied in layers, it is undesirable to heat previously deposited tows or to overheat the substrate. Conventionally, AMMs of this nature have required a different end effector for each size of tow, in order to control the size of heating for the different tow sizes. This has resulted in significant cost for the multiple end effectors, storage and maintenance of same, and increases the time to apply multiple tow sizes on a particular workpiece or series of workpieces. Accordingly, there is a need for reducing the cost and time for operating an AMM using different tow sizes.

### SUMMARY OF THE DISCLOSURE

This Summary introduces a selection of concepts in a simplified form in order to provide a basic understanding of some aspects of the present disclosure. This Summary is not an extensive overview of the disclosure, and is not intended to identify key or critical elements of the disclosure or to delineate the scope of the disclosure. This Summary merely presents some of the concepts of the disclosure as a prelude to the Detailed Description provided below. The term “telescope” is used herein to describe a device, box, mechanism or the like that holds arrangement of lenses for focusing laser light in a predetermined manner. The inventors do not necessarily claim that the device holding lenses according to embodiments disclosed herein would be useful for optical viewing of distant objects in the manner of a common telescope.

According to an embodiment, a telescope box for use in an additive manufacturing machine (AMM) includes a support structure, one or more optical lenses, and one or more mechanical attachment structures. The support structure holds the one or more optical the configured lenses disposed in a predetermined arrangement. The one or more optical lenses are arranged to achieve a predetermined projected size of a received laser beam to correspond with a selected tow size. The one or more mechanical attachment structures are configured for attaching the telescope box to the AMM.

According to another embodiment, an additive manufacturing machine includes an articulated robotic arm, an end effector, and a telescope support structure. The robotic arm is configured for stable mounting to a floor or platform. The end effector is operably connected to an end of the robotic arm, and includes a tow feed mechanism, a laser source, and a telescope box. The tow feed mechanism is configured to convey, for application to a workpiece, at least a first tow selected from among a plurality of tows having differing widths. The laser source is configured to supply heat, via a laser beam, to at least the first tow as it is applied to the workpiece. The telescope box includes a support structure holding one or more optical lenses disposed in a predetermined arrangement. The one or more optical lenses are configured to focus the laser beam received from the laser source to a size that corresponds to a size of the first tow. The telescope box support structure is configured to interchangeably hold the telescope box, among a plurality of interchangeable telescope boxes, between the laser source and the workpiece.

According to an embodiment, a method of changing a laser beam size of a laser source in an additive manufacturing machine (AMM) that is configured to feed to a workpiece a selected tow from a plurality of tows each having a different tow width, includes several operations. In one operation a laser focusing telescope is selected, from a plurality of interchangeable laser focusing telescopes each configured for a different tow size, the selected laser focusing telescope corresponding to the selected tow. The operation also includes installing the selected laser focusing telescope in the AMM. Another operation includes providing laser energy, from a laser source of the AMM, to the selected laser focusing telescope. Another operation includes replacing the selected laser focusing telescope with a laser focusing telescope configured for a different laser beam size when a tow of a different width is selected from the plurality of tows.

Further scope of applicability of the present invention will become apparent from the Detailed Description given below. However, the Detailed Description and specific examples, while indicating preferred embodiments of the present invention, are given by way of illustration only, since various changes and modifications within the spirit and scope of the present invention will become apparent to those skilled in the art from this Detailed Description.

### BRIEF DESCRIPTION OF THE FIGURES

These and other objects, features and characteristics of the present disclosure will become more apparent to those skilled in the art from a study of the following Detailed Description in conjunction with the appended claims and drawings, all of which form a part of this specification. In the drawings:

FIG. 1 is a block diagram illustrating an Additive Manufacturing Machine (AMM), according to an embodiment;

FIG. 2 illustrates a laser source, according to an embodiment;

FIGS. 3A-3C illustrate perspective views of a tow and the laser spot or projection overlapping the width of the tow having different spot or projection shapes, according to an embodiment;

FIGS. 4-9 are cross-sectional views of different telescope boxes, according to an embodiment; and

FIG. 10 is a flow chart illustrating operations of a method for changing a laser spot size in and additive manufacturing machine, according to an embodiment.

### DETAILED DESCRIPTION

Various examples of the present invention will now be described. The following description provides specific details for a thorough understanding and enabling description of these examples. One skilled in the relevant art will understand, however, that the present invention may be practiced without many of these details. Likewise, one skilled in the relevant art will also understand that the present invention can include many other obvious features not described in detail herein. Additionally, some well-known structures or functions may not be shown or described in detail below, to avoid unnecessarily obscuring the relevant description.

Descriptions of well-known starting materials, processing techniques, components and equipment may be omitted so as not to unnecessarily obscure the present invention in detail. It should be understood, however, that the detailed description and the specific examples, while indicating (e.g., preferred) embodiments of the present invention, are given by way of illustration only and not by way of limitation. Various substitutions, modifications, additions and/or rearrangements within the spirit and/or scope of the underlying inventive concept will become apparent to those skilled in the art from this disclosure.

An additive manufacturing machine (AMM) may be stationed in a room where it can additively apply material, such as fiber tows, to a workpiece which may be mounted on a platform which may be rotatable along at least one axis. The AMM may include a robot (e.g., robot arm) that performs operations on the workpiece. According to an embodiment, the robot arm may include an articulated arm. The AMM may further include an end effector mounted to the end of the robot arm. An AMM can be implemented in other forms as well.

The AMM and/or the workpiece may be moved relative to the other by action of the robot and the turntable. The end effector may make contact with the workpiece as the AMM lays down a single bundle or strand of reinforcing fibers (“tow”) such as Carbon Fiber Reinforced Polymer (CFRP). A CFRP tow may be 0.007″ thick and any of ⅛″, ¼″ or ½″ inch wide. Applicant acknowledges that a plurality of strands or tows may be applied simultaneously in some embodiments, and that the disclosed devices and methods may, without departing from the scope of the disclosure, be applied to tows having widths and/or thicknesses other than mentioned above. The thickness of the tow may vary by manufacturer. For example; a thickness of 0.010″ is also popular. Typically, the tow is impregnated with a heat activated resin. The tow is added to the workpiece and is made to adhere to the workpiece by heating previously added tows on the workpiece and/or the descending tow, making them sticky, using an infrared laser source. This heat can be directed to a nip point (e.g., point where the tow is pressed down onto the substrate by the compaction roller) by the infrared laser source.

Lasers are frequently used in additive manufacturing whether it be for automatic fiber placement (AFP), fused filament fabrication (FFF), or fused granular fabrication (FGF). The laser is used to heat or cure either the material being deposited, the substrate, or both.

Conventional systems are designed to only be used for one material width and as such have discrete optics assemblies to shape the beam to a fixed dimension. When the dimension of the feedstock is changed, the beam shape is no longer optimal, either being undersized or oversized, and thus insufficient heats the tow or undesirably heats elements in addition to the tow.

According to the present disclosure, an additive manufacturing machine (AMM) can be reconfigured for various tow widths. This has the advantage of minimizing the number of robots, rooms, and/or end effectors needed in a facility that utilizes more than one tow size. One of the adjustments to the AMM is the width of a laser spot that shines on the nip point. Here “laser spot” can refer to light directed to a specific shape including, but not limited to, a round, oval, square, or rectangular. According to an embodiment, this spot is made slightly greater than the width of the descending tow. The present disclosure describes an apparatus and/or method to adjust the spot size of the laser to match the tow width.

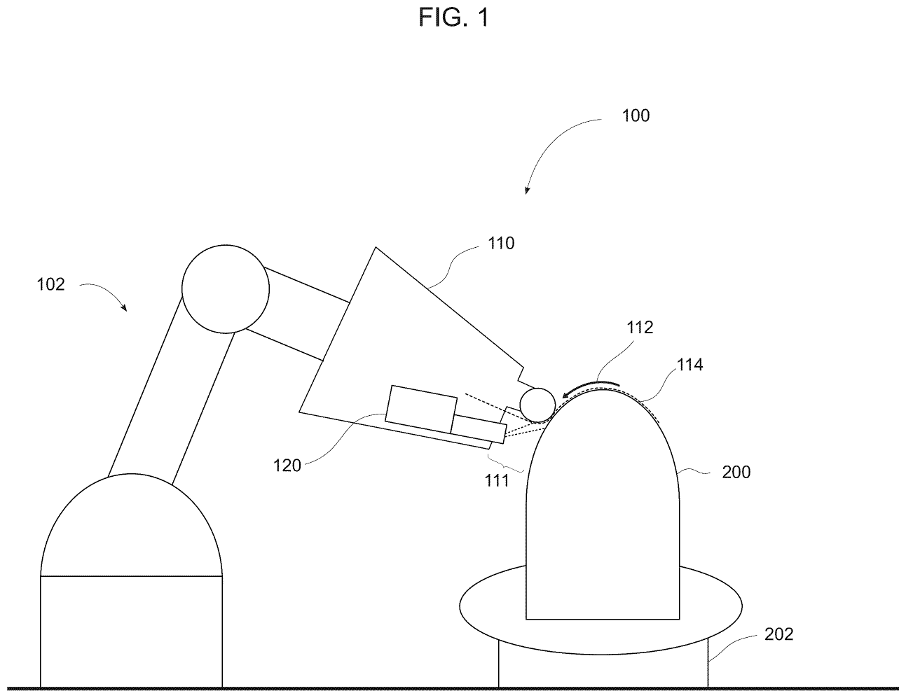

FIG. 1 is a block diagram illustrating an Additive Manufacturing Machine (AMM) 100, according to an embodiment. The AMM 100 may include a robot or robotic arm 102 having an end effector 110. The end effector 110 may include a laser source 120 configured for directing heat energy (via a laser beam) to heat a tow 114 as the tow is placed along a tow path 112 on a workpiece 200. The workpiece 200 may be mounted on a pedestal having a rotator 202.

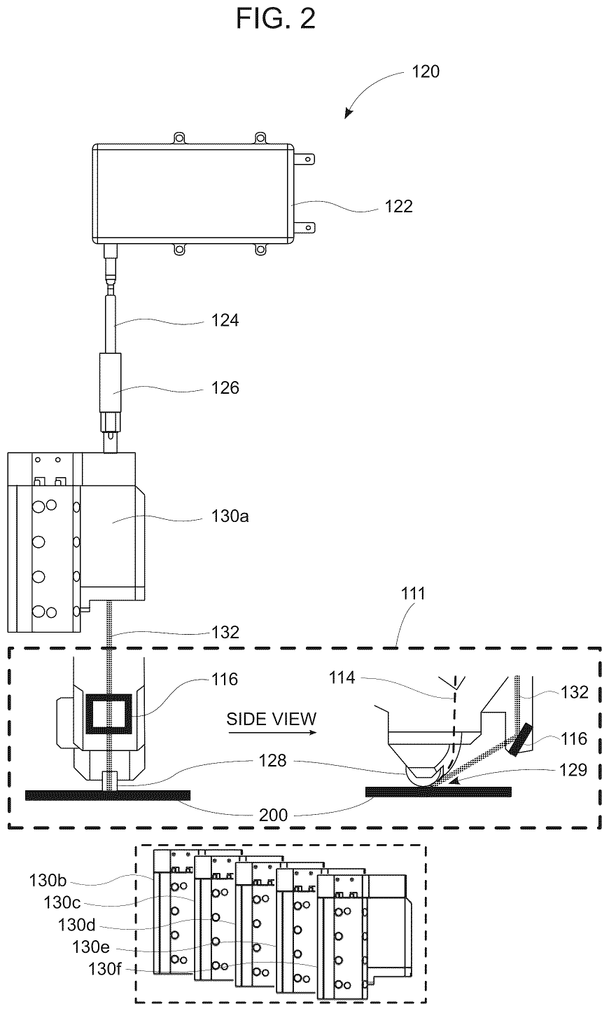

FIG. 2 illustrates a laser source 120, according to an embodiment. The laser source 120 may include a laser 122. The laser 122 may be an infrared laser (such as an nLight 400W laser) configured to direct a laser beam and associated heat via a flexible fiber-optic output line 124. In some embodiments, the fiber-optic output line 124 may have a square cross section (not illustrated specifically). However, Applicant acknowledges that other fiber-optic line cross-sectional shapes may be used, e.g., circular, oval, rectangular, etc. The fiber-optic line 124 is operably connected to a fiber termination 126 which provides a non-diverging output. The fiber termination 126 provides a diverging laser beam to be subsequently shaped by a “telescope” box (any of 130a-130f)).

The fiber-optic line 124 may be directed to pass light into the “telescope” box (also referenced as “interchangeable lens stack unit,” any of 130a, 130b, 130c, 130d, 130e, 130f) comprising one or more lenses, each telescope box configured to one of several lens arrangements corresponding to respective tow widths and/or laser projection shapes. That is, according to an embodiment, each of a plurality of interchangeable telescope boxes (e.g., 130a, 130b, 130c, 130d, 130e, 130f) may be respectively configured to direct light from the laser 122 in a laser spot size corresponding to tows having respectively different tow widths. A mirror or prism 116 may be disposed beyond a light outlet of the telescope box 130a to redirect the laser spot/projection to the nip point 129. FIG. 2 includes front and “side” views of a tow applicator portion 111 of the end effector, illustrating redirection of the beam 132.

The telescope box 130a in FIG. 2 may be exchanged for a telescope box 130b, 130c, 130d, 130e, or 130f (bottom of FIG. 2) for example, each corresponding to a different tow width and/or laser spot pattern. Those having skill in the art will acknowledge that the beam 132 projected from the telescope box will have different a different width depending on which telescope box is selected. For example, the beam 132 in FIG. 2 may correspond to a beam output for a ⅛-inch-wide tow. The appropriate telescope box 130a, 130b, 130c, 130d, 130e, or 130f is selected based at least on the width of a tow that is loaded into and/or fed by the end effector 110. The laser light 132 modified by the telescope box 130a, 130b, 130c, 130d, 130e, or 130f is output from the telescope box onto a tow 114 at or near a nip point 129. The tow may be tensioned in part by a compaction roller 128 of the end effector as the tow is being applied to a workpiece. In another embodiment, a single telescope box (e.g., 130a) may be mechanically or manually controlled to configure the lenses of the telescope box to one of plural selectable telescope configurations respectively corresponding to different tow widths.

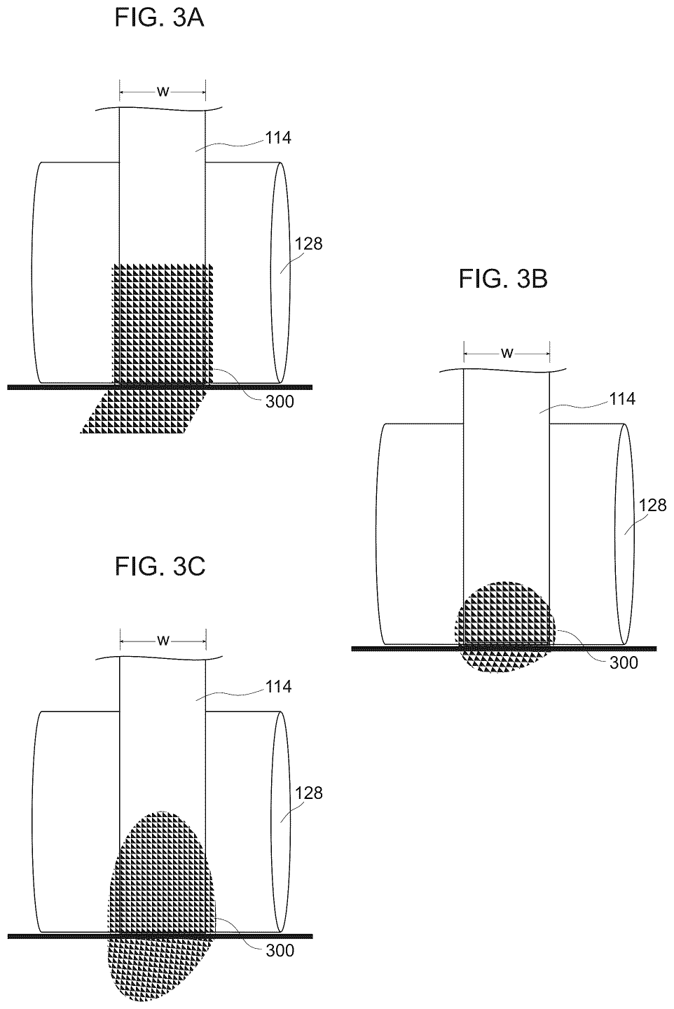

The size of the laser spot or projection is determined by the selected telescope configuration such that the projected spot covers the descending tow 114 with a slight overlap on each side. For example, in a non-limiting example, the overlap may be 1 mm according to one embodiment. FIGS. 3A-3C illustrate front views of a tow 114 and the laser spot or projection 300 overlapping the width W of the tow 114 during application of the tow 114 to a substrate 200 by a compaction roller 128, according to an embodiment. While FIG. 3A shows the spot/projection 300 as rectangular, FIGS. 3B and 3C show the spot/projection 300 as circular and oval, respectively, each having a similar overlap to the sides of the tow width W.

When a square fiber-optic line is used, the infrared light directed into the telescope box 130a by the fiber-optic line is a square beam. In an embodiment that provides three lens configurations, outputs of the telescope box(es) may include:

For ⅛-inch-wide tow a telescope box 130a configuration may be selected that outputs a 4 mm×8 mm laser spot 300. The 4 mm dimension corresponds to, and overlaps, the width of the tow 114 as shown in FIG. 3A. Alternatively, a telescope box 130d configuration may be selected that outputs a 4 mm diameter round laser spot.

For ¼-inch-wide tow a telescope box 130b configuration may be selected that outputs an 8 mm×8 mm laser spot. In this instance, one of the 8 mm dimensions corresponds to, and overlaps, the width of the tow 114. Alternatively, a telescope box 130e configuration may be selected that outputs an 8 mm diameter round laser spot.

For ½-inch-wide tow a telescope configuration is selected that outputs a 13.4 mm×8 mm laser spot. In this instance the 13.4 mm dimension corresponds to, and overlaps, the width of the tow 114. Alternatively, a telescope box 130f configuration may be selected that outputs a 13.4 mm diameter round laser spot.

The telescope boxes 130a, 130b, 130c each may provide a rectangular heat beam 300 which, for purposes of AMM, is an optimum shape due to its length-dimension consistency across different tow widths. An oval has been contemplated by the inventors as well for similar reasons.

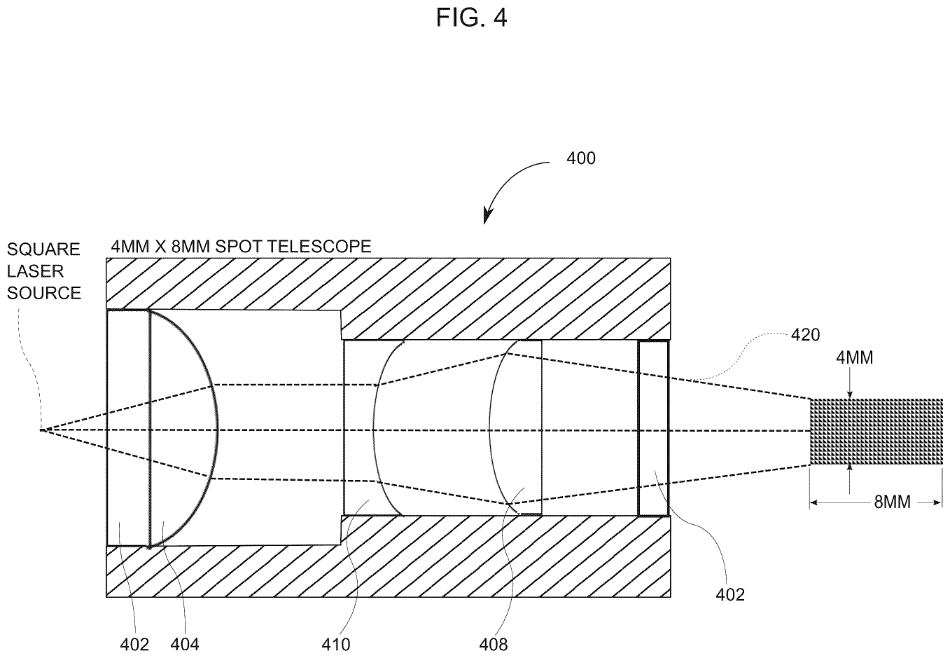

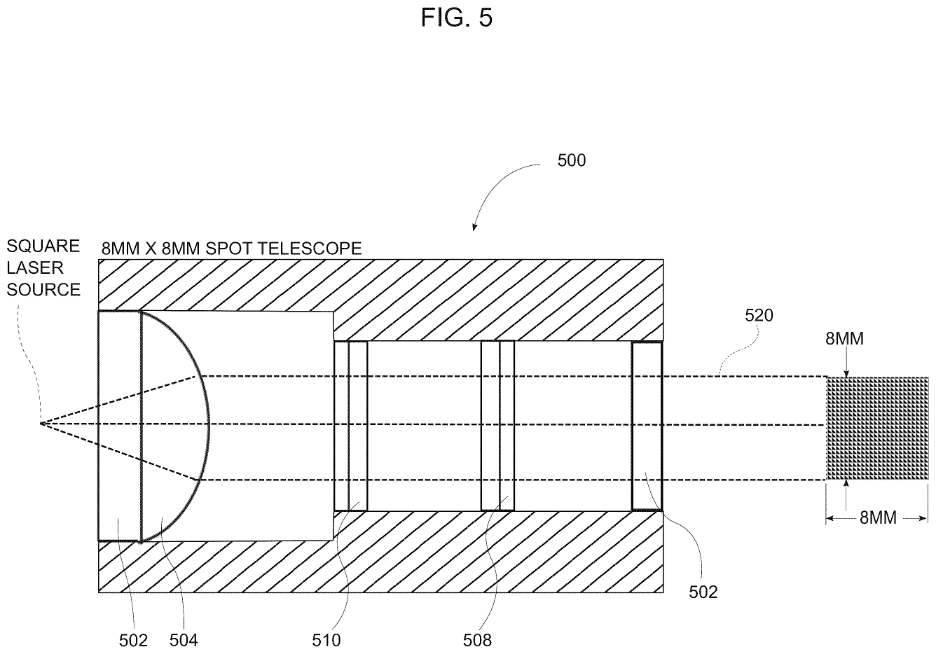

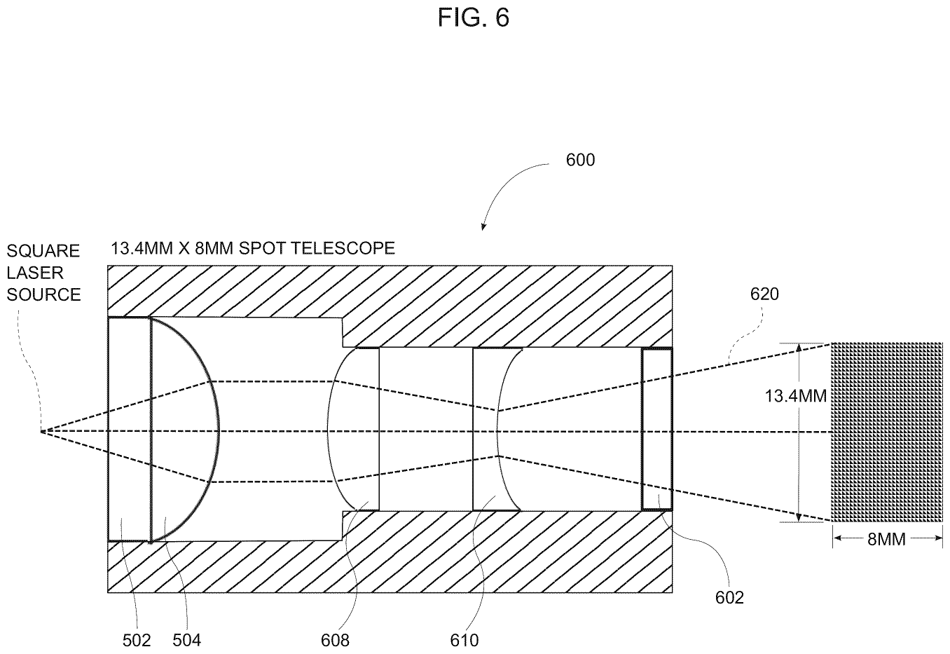

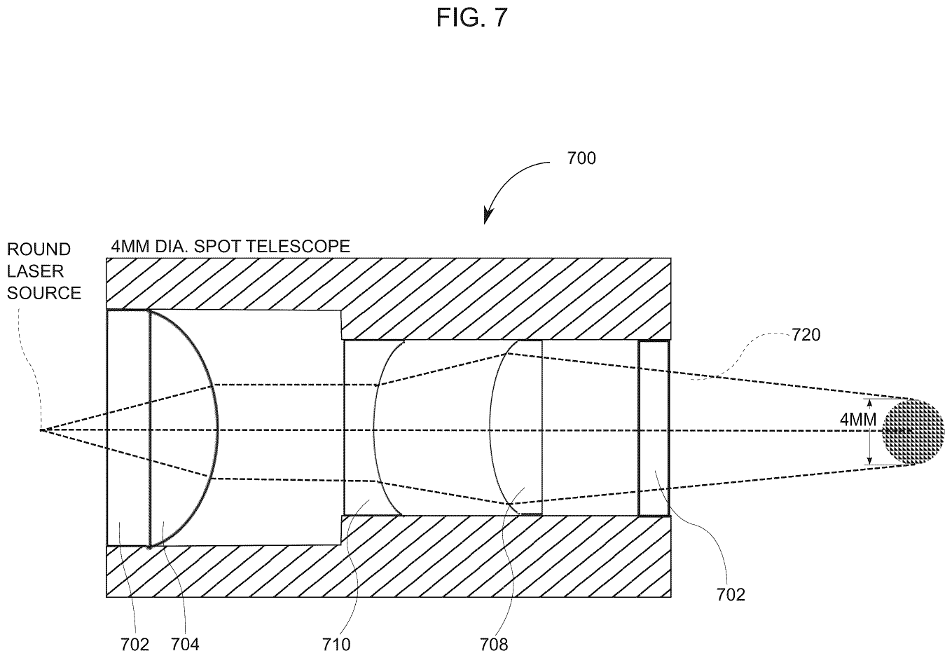

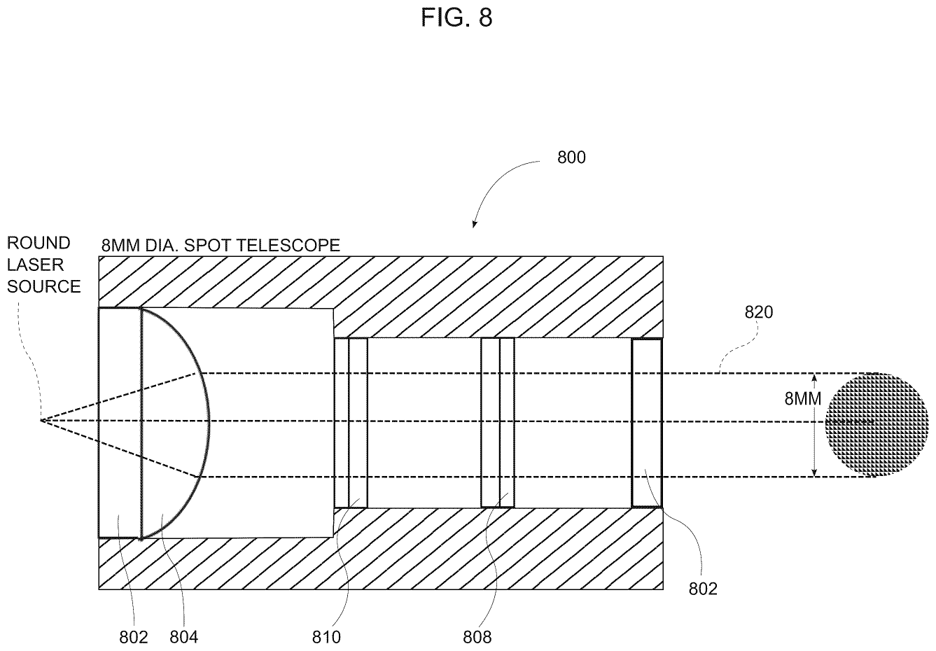

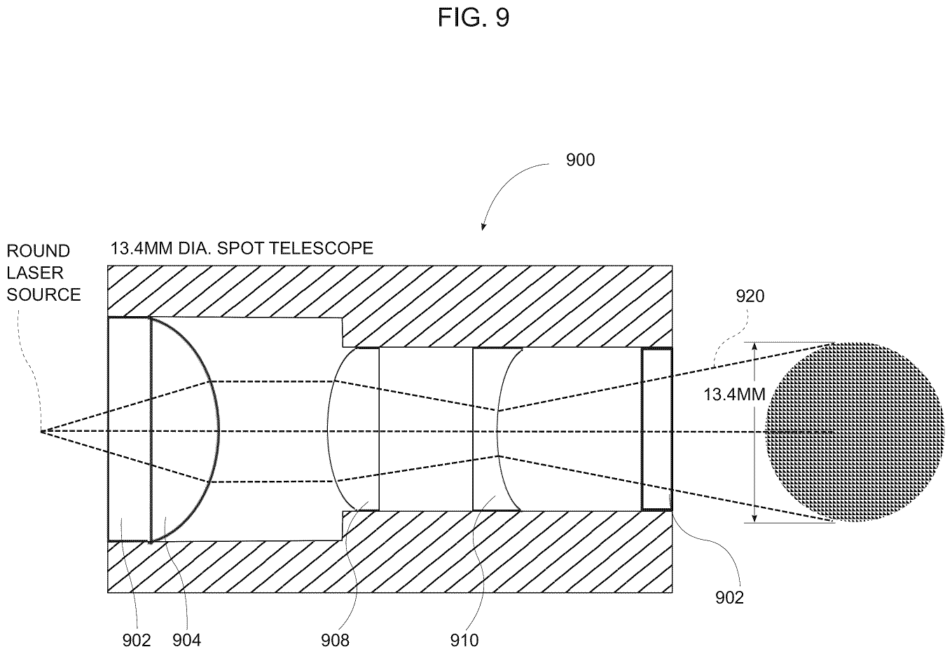

FIGS. 4-9 are cross sectional views of different telescope boxes 130a, 130b, 130c, 130d, 130e, 130f according to embodiments. Arrangements 400, 500, 600, 700, 800, and 900 of internal elements of the respective telescope boxes 130a, 130b, 130c, 130d, 130e, 130f are described below with reference to FIGS. 4-9. Each telescope box includes an arrangement of lenses 400, 500, 600, 700, 800, and 900 to achieve the heat beam 420, 520, 620, 720, 820, 920 of desired dimension. The lenses may include combinations of the following types of lenses as required for tow width.
Transparent cover 402, 502, 602, 702, 802, 902;
Plano-convex spherical lens 404, 504, 604, 704, 804, 904;
Plano-concave spherical lens 406, 606, 706;
Plano-convex cylindrical lens 708, 808, 908;
Plano-concave cylindrical lens 710, 810, 910;
   Each of the lenses may be of a spherical type (i.e., having uniform curvature) arranged to create a diverging nor non-diverging beam as needed.

When it is desired to feed a different tow 114 out of the AMM 100, the telescope box 130a, 130b, 130c, 130d, 130e, 130f may be exchanged to suit the tow. The overall length of the telescope box 130a, 130b, 130c, 130d, 130e, 130f may be the same for all tow widths to facilitate minimum adjustment of the end effector 110 of FIG. 1. The shape of the laser spot/projection 300 may depend on the shape of the laser beam provided to the telescope box, as indicated in FIGS. 4-9, according to an embodiment. Alternatively, the shape of the laser spot/projection 300 may be changed by a “windowing” feature in other embodiments. For example, an aperture formed by a beam shaper, optical elements, mirrors, blinds, shutters, stencils, and/or the like formed of appropriately heat-resistant material may be disposed in the beam path to affect the shape of the spot/projection 300.

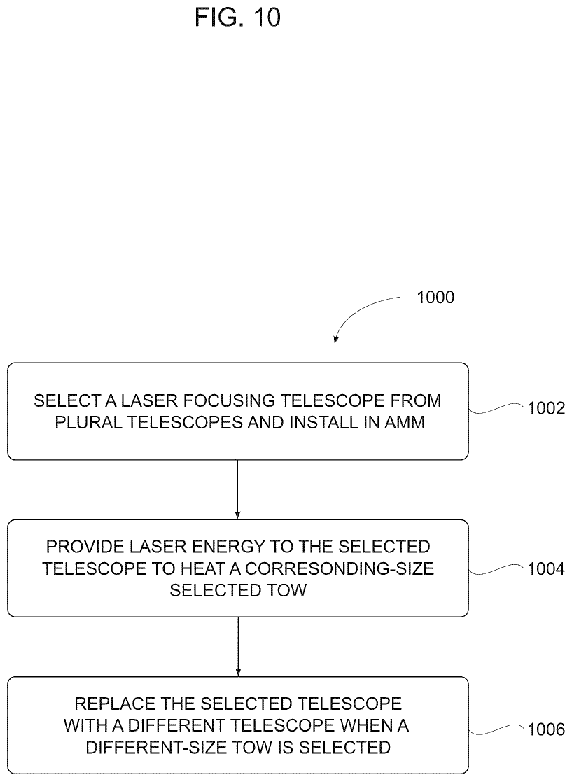

FIG. 10 is a flow chart illustrating operations of a method 1000 for changing a laser spot size in and additive manufacturing machine, according to an embodiment. In an operation 1002, a laser focusing telescope (e.g., telescope box 130a-130f) may be selected based on a selected tow size and installed in an additive manufacturing machine (AMM). For example, the selected laser focusing telescope may be installed the end effector of the AMM. In an operation 1004 laser energy may be provided to and focused by the selected laser focusing telescope to heat the selected tow. A mirror may be used to redirect the laser beam focused by the laser focusing telescope. In some embodiments, the laser focusing telescope may be configured to cooperate with the mirror to achieve the desired laser beam size and/or shape. In operation 1006, the selected laser focusing telescope may be replaced with a different laser focusing telescope when a different-sized tow is selected. For example, the selected laser focusing telescope may be exchanged for another when moving from one workpiece to another or when a different tow size is desired on the same workpiece.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Exemplary embodiments are shown and described in the present disclosure. It is to be understood that the embodiments are capable of use in various other combinations and environments and are capable of changes or modifications within the scope of the inventive concept as expressed herein. Some such variations may include using programs stored on non-transitory computer-readable media to enable computers and/or computer systems to carry a part of or all the method variations discussed above. Such variations are not to be regarded as departure from the spirit and scope of the invention, and all such modifications as would be obvious to one skilled in the art are intended to be included within the scope of the following claims.

What is claimed is:

1. A telescope box for use in an additive manufacturing machine (AMM), the telescope box comprising:
a support structure holding one or more optical lenses disposed in a predetermined arrangement;
the one or more optical lenses, arranged to achieve a predetermined projected size of a laser beam corresponding with a selected tow size; and
one or more mechanical attachment structures configured for attaching the telescope box to the AMM.

2. The telescope box according to claim 1, wherein the one or more mechanical attachment structures are further configured for repeatable exchange of the telescope mechanism with a second telescope box configured for a different predetermined tow size.

3. The telescope box according to claim 1, wherein the one or more optical lenses includes a plurality of optical lenses, and at least one lens of the plurality of optical lenses is movable with respect to another lens of the plurality of optical lenses, movement of the at least one lens changing a size of a laser pattern on at least one of a tow and a substrate to which the tow is applied.

4. The telescope box according to claim 1, wherein a laser light pattern projected from the arrangement of lenses has a rectangular shape.

5. The telescope box according to claim 1, further comprising a windowing feature configured to affect a shape of a laser pattern projected from the telescope box onto at least one of the tow and the substrate.

6. The telescope box according to claim 5, wherein the windowing feature is configured to limit the laser pattern to a rectangular shape.

7. The telescope box according to claim 5, wherein the windowing feature is configured to limit the laser pattern to a circular or oval shape.

8. An additive manufacturing machine, comprising:
a robotic arm; and
an end effector operably connected to an end of the robotic arm, the end effector including:
a tow feed mechanism configured to convey for application to a workpiece at least a first tow selected from among a plurality of tows having differing widths,
a laser source configured to supply heat, via a laser beam, to at least the first tow as it is applied to the workpiece, and
telescope box including a support structure holding one or more optical lenses disposed in a predetermined arrangement, the one or more optical lenses being configured to focus the received laser beam to a size that corresponds to a size of the first tow; and
a telescope box support structure configured to interchangeably hold the telescope box selected from among a plurality of interchangeable telescope boxes, between the laser source and the workpiece.

9. The additive manufacturing machine according to claim 8, wherein a laser light pattern projected from the selected telescope box has a rectangular shape.

10. The additive manufacturing machine according to claim 8, wherein the telescope box support structure is further configured for repeatable exchange of the telescope box with a second telescope box configured for a different predetermined tow size.

11. The additive manufacturing machine according to claim 8, wherein the one or more optical lenses includes a plurality of optical lenses, and at least one lens of the plurality of optical lenses is movable with respect to another lens of the plurality of optical lenses, movement of the at least one lens changing a size of a laser pattern on at least one of the tow and a substrate of the workpiece to which the tow is applied.

12. The additive manufacturing machine according to claim 10, further comprising a windowing feature configured to affect a shape of the laser pattern on the at least one of the tow and the substrate.

13. The additive manufacturing machine according to claim 12, wherein the windowing feature is configured to limit the laser pattern to a rectangular shape.

14. The additive manufacturing machine according to claim 12, wherein the windowing feature is configured to limit the laser pattern to a circular or oval shape.

15. A method of changing a laser beam size of a laser source in an additive manufacturing machine (AMM) configured to feed to a workpiece a selected tow from a plurality of tows each having a different tow width, the method comprising the operations of:
selecting, from a plurality of interchangeable laser focusing telescopes each configured for a different tow size, a laser focusing telescope, corresponding to the selected tow, and installing the selected laser focusing telescope in the AMM;
providing laser energy, from a laser source of the AMM, to the selected laser focusing telescope; and
replacing the selected laser focusing telescope with a laser focusing telescope configured for a different laser pattern width, a different laser pattern shape, or both a different laser pattern width and a different laser pattern shape, when a tow of a different width is selected from the plurality of tows.

16. The method according to claim 15, wherein said selecting a laser focusing telescope corresponding to the selected tow from a plurality of laser focusing telescopes is performed by the AMM based on information received in an electronic instruction.

17. The method according to claim 16, further comprising operating a robotic arm of the AMM to engage the laser focusing telescope based on the electronic instruction.

18. The method according to claim 16, wherein the electronic instruction is part of a program received by the AMM, the program configured to direct operations for placing tows on the workpiece.

19. The method according to claim 15, wherein said providing laser energy from a laser source of the AMM includes emitting laser energy from the laser source via a fiber-optic line to the selected laser focusing telescope.

20. The method according to claim 15, wherein said replacing the selected laser focusing telescope with a laser focusing telescope configured for a different laser pattern size and/or shape includes executing an electronic instruction received by the AMM.

21. The method according to claim 20, wherein the electronic instruction includes computer code interpreted by the AMM to operate an articulable robotic arm to deposit the selected laser focusing telescope and to engage the configured for the different laser pattern size and/or shape.
